(19) United States
(12) Patent Application Publication
(10) Pub. No.: US 2010/0295197 A1
(43) Pub. Date: Nov. 25, 2010

(54) CEMENT ROOF FORM AND METHOD OF USE

(76) Inventor: Steven Weitzman, Brentwood, MD (US)

Correspondence Address: LAW OFFICES OF WILLIAM H. HOLT, 12311 HARBOR DRIVE, WOODBRIDGE, VA, 22192, US

(21) Appl. No.: 12/303,741

(22) PCT Filed: Jun. 5, 2007
(86) PCT No.: PCT/US07/13162

§ 371 Date: Dec. 7, 2008

Related U.S. Application Data
(60) Provisional application No. 60/804,249, filed on Jun. 8, 2006.

(51) Int. Cl. B29C 45/14

(52) U.S. Cl. 264/33; 264/35; 425/542

(57) ABSTRACT

A mold form is constructed for being placed in spaced relation adjacent a surface upon which a designed surface is desired. A mixture of moldable material is introduced between the mold form and the surface and is cured in-situ. One preferred design is an overlay for a conventional cement roof having an original smooth finish such that the finished design resembles a ceramic tile roof. Various other designs made be used including diamond or triangular designs, or artistic designs in low or high relief, i.e., in figures or forms that project from a flat background, as in sculpture.

The invention relates to a novel apparatus and method for improving the appearance of an existing roof on buildings including commercial buildings, residential homes and the like, by providing an overlay of additional roofing material over an existing roof, the overlay having a molded relief in the form of a finished design.

### BACKGROUND OF THE INVENTION

It is known in the prior art to provide houses and various types of commercial and noncommercial buildings with a roof formed of concrete. Roofs of this type usually have a fairly smooth surface that leaves much to be desired with respect to providing a pleasing appearance, particularly for slanted roofs that are visible from ground or street level.

### SUMMARY OF THE INVENTION

The present invention provides improvements over the prior art by producing a desirable and enhanced, finished appearance including a relief design to heretofore mundane looking, smooth, concrete roofs.

The invention also provides additional protection against adverse weather conditions such as rain, snow and sun, and improved wind resistance against high winds, hurricanes and the like, as compared to conventional overlays of ceramic tile, wooden shakes, shingles, or slate, because moldable material such as a cement overlay can be made to bond to the underlying surface.

The invention comprises the provision of one or more mold frames and a method of using the same for forming, in-situ, an overlying layer of moldable material, preferably a moldable cement mixture, upon an existing roof for providing a decorative finish that, in effect, mimics the appearance of a plurality, or series, of ceramic roof tiles of varying designs, including Spanish tiles, Bermuda tiles, cement tiles, and the like, or may also be provided with various geometric designs such as diamond shapes, or triangles, or hexagons, etc., or any of a myriad of various artistic designs such as animals, or plant leaves, etc.

The moldable material, preferably a cement, or mixtures thereof which may be composed of various compositions of hydraulic cements, Portland cement, admixtures of cement, fibrous material and/or polymers, and the like, depending upon expected variables in temperature created by freeze-thaw cycles in cold climates, or high temperatures created by exposure to the sun in tropical environs and, if desired can also contain coloring material for providing a decorative, colored finish.

### BRIEF DESCRIPTION OF THE DRAWINGS

FIG. 1 is a perspective view of the top side of a mold form which is usable for casting a panel, or overlay, that mimics what is generally known as Spanish roof tile.

FIG. 2 is an elevational view of a wall member for a front wall, or a rear wall, of the mold form of FIG. 1.

FIG. 3 is an elevational view of a wall member for a left side wall, or a right side, of the mold form of FIG. 1.

### DETAILED DESCRIPTION OF THE INVENTION

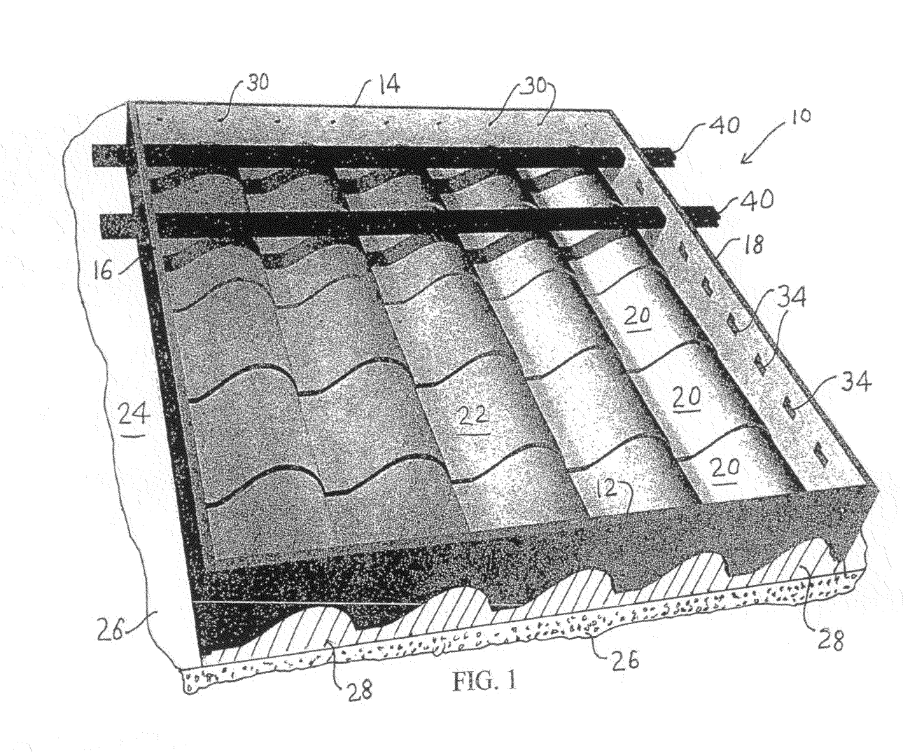

As is best shown in FIG. 1, a mold form, generally indicated by the numeral 10, is comprised of a front wall 12, a rear wall 14, a left side wall 16 and a right side wall 18 which form a peripheral wall about mold form 10 and define a central enclosure. Disposed in the space between the peripheral walls is a series of one or more sheet members 20 which, together, comprise a top cover 22 of the central enclosure of mold form 10. The underside of cover 22 functions as a mold surface that is configured or shaped to produce a relief design on moldable material coming in connect with cover 22 when a sufficient amount of moldable material is poured into or injected under pressure into the central enclosure beneath the cover 22.

When in use, mold form 10 is adapted to be disposed adjacent to, and in contact with, a planar surface 24 which in one embodiment of the invention is comprised of an underlying section of a previously formed cement roof 26. As is best shown in FIG. 1, the space between the cement roof 26 and the underside of cover 22 becomes filled with moldable material 28 which cures to form a relief-shaped overlay that mimics Spanish tile.

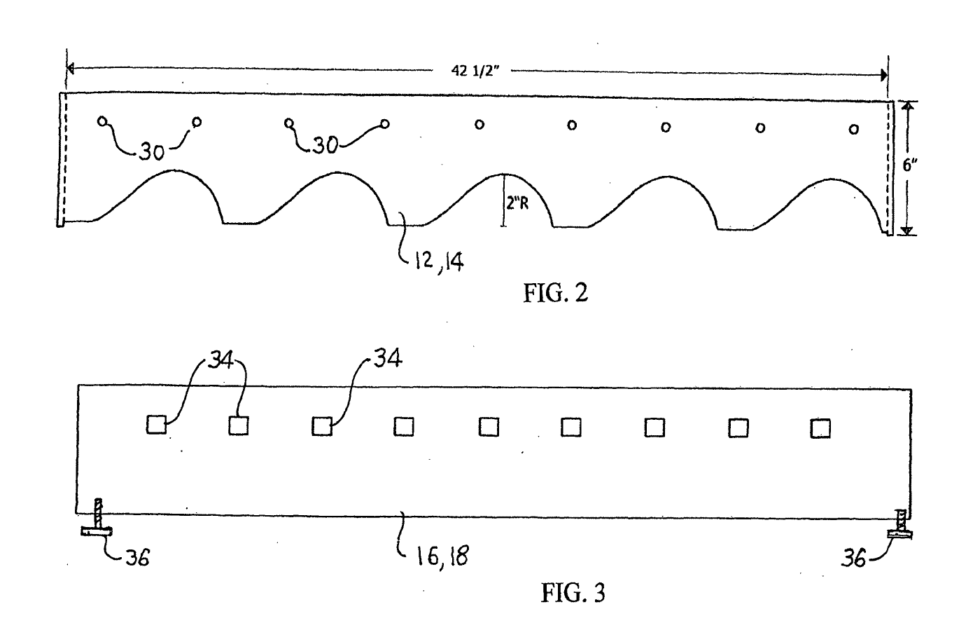

FIG. 2 shows an elevational view of a front wall 12 (similar to rear wall 14) which is provided with a series of bolt holes 30 spaced along the length of wall 12. Preferably, bolt holes 30 are internally threaded for receiving threaded bolts (not shown) for securing wall 12 (or wall 14)to a wall of an adjacently placed second mold frame (not shown) for purposes of registration and also security against slippage which would result in a consequential mismatch of adjoining overlays.

FIG. 3 is an elevational view of left wall 16, or right wall 18, having a plurality of threaded, adjustable legs for raising or lowering the mold form 10 for increasing or decreasing the volume of the central enclosure beneath cover 22. In this way, the thickness, or height and weight of the molded underlay can be readily adjusted. Further, the, left and right walls 16 and 18 contain a series of spaced openings 34 for receiving therethrough a plurality of individual bars 40 (as shown in FIG. 1) which keep the mold form 10 rigid and allow for registration with an adjacent mold form (not shown). It is to be understood that the portions of bars 40 extending outwardly from walls 16 and 18 will register with comparable openings in an adjacent mold form, while bars from the adjacent mold form will register with alternate openings in mold form 10. Thus, adjacent mold forms are registered with each other and protected against slippage.

It is to be understood that the plurality of mold forms 10 are a high quality, re-usable product preferably manufactured of high impact fiberglass. Once the moldable material cures to form a first desired overlay, the mold form 10 is raised therefrom and can be repositioned adjacent to the formed overlay and/or adjacent to, and secured to an adjacent mold form.

In view of the foregoing, it will be seen that various methods and apparatus have been disclosed for enhancing the appearance of heretofore mundane appearing surfaces but it should be understood that the foregoing descriptions are by way of illustration, and the invention is not necessarily limited thereto. Modifications and variations will be apparent from the disclosure and may be resorted to without departing from the spirit of the invention as those of skill in the art will readily understand. Accordingly, such variations and modifications are considered to be within the purview and scope of the invention as defined in the following claimed subject matter.

1. A process for enhancing appearance of roofing of buildings, said process comprising the steps of placing a mold form over at least a portion of a pre-existing roof, said mold form having an underside that is configured for producing a finished surface having a desirable appearance, introducing a mixture of moldable material between, said mold form and said pre-existing roof, curing said mixture of moldable material in-situ, and removing said mold form for exposing said finished surface on top of said pre-existing roof.

2. A process as defined in claim 1 wherein said underside of said mold form is configured for producing a finished, three dimensional surface that mimics the appearance of a ceramic tile roof.

3. A process as defined in claim 1 including the step of relocating said mold form to a position adjacent to said finished surface, and repeating the step of introducing a mixture of moldable material between said mold form and said pre-existing roof.

4. A process as defined in claim 1 wherein said mixture of moldable material is introduced between said mold form and said underlying roof.

5. A process as defined in claim 4 wherein said mixture of moldable material is injected under pressure between said mold form and said roof.

6. A mold form for use with the process of claim 1, said mold form having a peripheral outer wall forming a central enclosure, a top portion co-extensive with and providing a cover for said central enclosure, said top portion including design means on an underside thereof facing said central enclosure, and access means for introducing said mixture of moldable material into said central enclosure and into contact with said design means.

7. A mold form as defined in claim 6 including a plurality of adjustable legs located at spaced locations on a lower portion of said peripheral outer wall for varying the volume of said central enclosure.

8. A mold form for enhancing the appearance of a generally planar surface, said mold form having a peripheral wall forming a central enclosure, a top portion co-extensive with and providing a cover for said central enclosure, said top portion including design means on an underside thereof facing said central enclosure, and access means for introducing a mixture of moldable material into said central enclosure and into contact with said design means.

9. A mold form as defined in claim 8 including a plurality of adjustable legs located at spaced locations on a lower portion of said peripheral wall for varying the volume of said central enclosure.

10. A mold form as defined in claim 8 wherein said peripheral wall is provided with a plurality of spaced openings, and a series of rod means inserted within said openings for keeping said mold form rigid, and providing for registration between adjacent mold forms.

11. A mold form as defined in claim 8 wherein said design means creates a cast in a three dimensional relief.

12. A mold as defined in claim 11 wherein said three dimensional relief mimics ceramic tiles.
